(19) United States
(12) Patent Application Publication
(10) Pub. No.: US 2022/0152787 A1
(43) Pub. Date: May 19, 2022

(54) PROCESSING APPARATUS

(71) Applicant: DISCO CORPORATION, Tokyo (JP)

(72) Inventor: Toshiyuki MORIYA, Tokyo (JP)

(21) Appl. No.: 17/452,667

(22) Filed: Oct. 28, 2021

(30) Foreign Application Priority Data
Nov. 16, 2020 (JP) 2020-189982

(51) Int. Cl. B25B 11/00; B24B 37/30

(52) U.S. Cl. CPC B25B 11/005; B24B 37/30

(57) ABSTRACT

A processing apparatus includes a chuck table, a processing unit that has a spindle, a spindle housing, and a mount section fixed to a lower end portion of the spindle, a processing feeding mechanism that puts the processing unit into processing feeding, a processing chamber cover that has an opening penetrable by the mount section and that is able to cover the chuck table and the mount section, an extendable cover section having an annular lower connection section detachably connected to a peripheral portion of the opening, an annular upper connection section fixed to the spindle housing, and a tubular bellows section that connects the upper and lower connection sections and that is able to shrink and extend following movement of the processing unit, and a gas flow forming unit that forms a flow of gas from the upper connection section toward the lower connection section inside the bellows section.

### BACKGROUND OF THE INVENTION

### Field of the Invention

The present invention relates to a processing apparatus that has a chuck table, a spindle, and a mount section fixed to a lower end portion of the spindle and that processes a workpiece held on a holding surface of the chuck table by a processing tool mounted to a lower surface side of the mount section.

### Description of the Related Art

A grinding apparatus for grinding a workpiece has a chuck table for holding under suction the workpiece thereon. On an upper side of the chuck table, a cylindrical spindle and a spindle housing accommodating the spindle in a rotatable manner are disposed. A motor is provided at an upper end portion of the spindle, and a disc-shaped wheel mount is fixed to a lower end portion of the spindle projecting from the spindle housing. An annular grinding wheel is mounted to a lower surface side of the wheel mount.

The spindle housing, the spindle, the motor, the wheel mount, the grinding wheel and the like constitute a grinding unit. A grinding feeding mechanism is connected to the spindle housing, and the grinding unit is movable in the vertical direction by the grinding feeding mechanism. A processing chamber cover may be provided for covering the chuck table and the grinding wheel. An upper plate of the processing chamber cover is formed with an opening such that the wheel mount and the grinding wheel can enter and exit therefrom, and, at the time of grinding the workpiece, the grinding wheel is disposed in a space (processing chamber) covered by the processing chamber cover.

At the time of grinding, the workpiece is ground while grinding water is being supplied, so that the grinding water containing grinding swarf is scattered in a mist form to a periphery, but the scattering range of the mist of the grinding water is limited to a certain extent by the processing chamber cover. It is to be noted, however, that the mist of the grinding water can leak out to the upper side through the opening of the upper plate of the processing chamber cover.

Incidentally, in the polishing apparatus, for preventing scattering of polishing swarf or the like, it has been known to provide a tubular bellows section which is extendable in the vertical direction, on an upper side of a peripheral portion of the opening of the upper plate (see, for example, Japanese Patent Laid-open No. 2017-80823). If this bellows section is provided for the grinding apparatus, a large number of grinding swarf particles are deposited on the inside of the bellows section. At the time of maintenance, the bellows section is shrunk such that a lower end portion of the bellows section makes contact with an upper end portion of the bellows section, and, when the grinding swarf deposited on the inside of the bellows section falls, and the grinding swarf is deposited on the holding surface and devices (a thickness measuring instrument, a grinding water supply nozzle, etc.) disposed in the processing chamber.

When the grinding swarf is deposited on the holding surface, troubles such as cracking and chipping of the workpiece are generated at the time of grinding. In addition, when the grinding swarf is deposited on the devices disposed in the processing chamber, troubles are generated in operations of the devices. For example, such troubles that the thickness of the workpiece cannot be accurately measured by the thickness measuring instrument or that grinding water is not supplied from the grinding water supply nozzle to the grinding region of the workpiece may be generated.

### SUMMARY OF THE INVENTION

The present invention has been made in consideration of such problems. It is an object of the present invention to reduce an amount of grinding swarf to be attached to the inside of a bellows section which is extendable in the vertical direction.

In accordance with an aspect of the present invention, there is provided a processing apparatus including a chuck table having a holding surface for holding a workpiece, a processing unit that has a spindle, a spindle housing holding the spindle in a rotatable manner, and a mount section fixed to a lower end portion of the spindle projecting below the spindle housing, the processing unit processing the workpiece held on the holding surface by a processing tool mounted to a lower surface side of the mount section, a processing feeding mechanism that puts the processing unit into downward processing feeding, a processing chamber cover that has an opening penetrable by the mount section and that is able to cover the chuck table and the mount section, an extendable cover section having an annular lower connection section detachably connected to a peripheral portion of the opening, an annular upper connection section fixed to the spindle housing, and a tubular bellows section that connects the upper connection section and the lower connection section and that is able to shrink and extend following upward and downward movement of the processing unit, and a gas flow forming unit that forms a flow of gas from the upper connection section toward the lower connection section inside the bellows section.

Preferably, the gas flow forming unit has any one of one nozzle disposed at the upper connection section, a plurality of nozzles disposed discretely at the upper connection section along a circumferential direction of the upper connection section, and an annular nozzle disposed at the upper connection section.

The processing apparatus according to one mode of the present invention has the extendable cover section that has the upper connection section, the lower connection section, and the bellows section connecting the upper connection section and the lower connection section. The processing apparatus further includes the gas flow forming unit that forms a flow of gas from the upper connection section toward the lower connection section inside the bellows section. The flow of the gas formed by the gas flow forming unit ensures that the mist of the grinding water containing grinding swarf is not liable to rise from the inside of the processing chamber cover to the bellows section. Therefore, it is possible to reduce an amount of the grinding swarf that could be attached to the inside of the bellows section.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a grinding apparatus;

FIG. 2 is a partly sectional side view of the grinding apparatus;

FIG. 3A is a perspective view of a processing chamber cover;

FIG. 3B is a perspective view of the processing chamber cover and an extendable cover section;

FIG. 4A is a top plan view of an upper ring depicting an example of a layout of a nozzle;

FIG. 4B is a top plan view of the upper ring depicting another example of the layout of the nozzle;

FIG. 5 is a partly sectional side view of a grinding apparatus according to a second embodiment;

FIG. 6A is a top plan view of an upper ring depicting an example of a layout of a plurality of nozzles;

FIG. 6B is a top plan view of the upper ring depicting another example of the layout of the plurality of nozzles; and

FIG. 7 is a top plan view of an upper ring depicting an example of a layout of a nozzle according to a third embodiment.

### DETAILED DESCRIPTION OF THE PREFERRED EMBODIMENTS

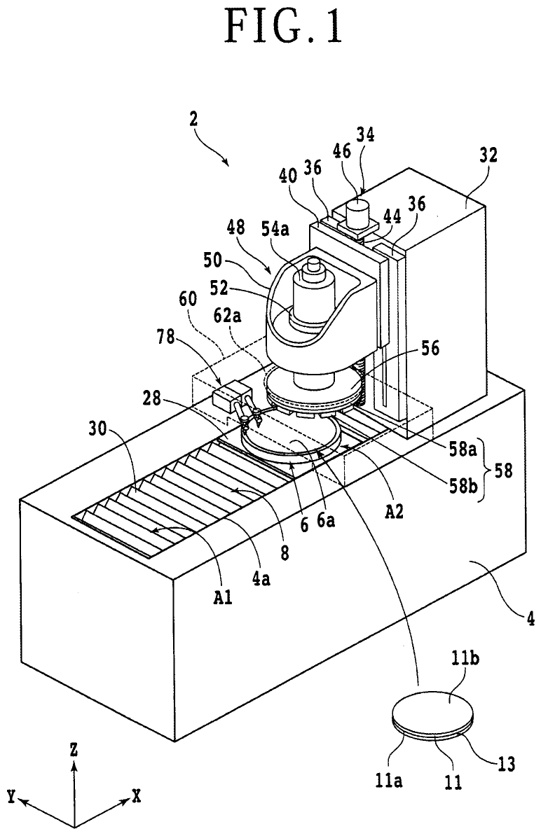

Referring to the attached drawings, an embodiment according to one mode of the present invention will be described. FIG. 1 is a perspective view of a grinding apparatus (processing apparatus) 2 according to a first embodiment. An X-axis direction (front-rear direction), a Y-axis direction, and a Z-axis direction (vertical direction or processing feeding direction) which are illustrated in FIG. 1 are orthogonal to one another. The grinding apparatus 2 of the present embodiment performs grinding of a workpiece 11, but loading, unloading, and the like of the workpiece 11 to/from the grinding apparatus 2 are carried out on a manual basis by an operator. Note that the grinding apparatus 2 may be of a full automatic system in which loading, grinding, cleaning, and unloading of the workpiece 11 are automatically carried out.

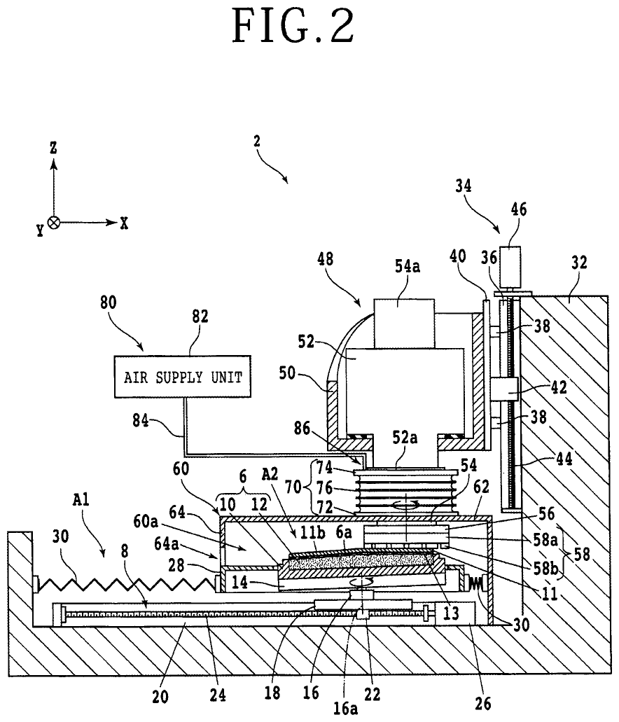

The grinding apparatus 2 has a base 4 that supports component elements. An upper surface of the base 4 is formed with a rectangular opening 4a having a longitudinal portion in the X-axis direction. In the opening 4a, there is provided an X-axis moving mechanism 8 that moves a chuck table 6 in the X-axis direction. Here, referring to FIG. 2, the chuck table 6 and the like will be described. FIG. 2 is a partly sectional side view of the grinding apparatus 2. The chuck table 6 has a disc-shaped frame body 10 formed of ceramic or the like. On an upper surface side of the frame body 10, a disc-shaped recess is formed.

In the recess, a disc-shaped porous plate 12 formed of a porous ceramic is fixed. The porous plate 12 has a substantially flat bottom surface, and an upper surface increased in thickness from a periphery toward a center. In other words, the upper surface of the porous plate 12 is a conical surface in which a central portion is slightly projecting as compared to a peripheral portion. A bottom surface of the recess of the frame body 10 is formed with a plurality of channels (not illustrated) which are formed radially. In addition, the frame body 10 is formed with a central channel (not illustrated) so as to be connected to the plurality of channels and penetrate the center of the bottom surface of the frame body 10.

A suction source (not illustrated) such as a vacuum pump is connected to the central channel, and, when the suction source is operated, a negative pressure is transmitted to the upper surface of the porous plate 12. Therefore, the upper surface of the porous plate 12 functions as a holding surface 6a for holding under suction the workpiece 11. The chuck table 6 is rotatably connected to an upper side of a disc-shaped table base 14 through a bearing (not illustrated). The table base 14 is formed with a through-hole (not illustrated).

A rotational drive source 16 such as a motor is disposed on a lower side of the table base 14, and a rotary shaft 16a of the rotational drive source 16 is connected to a bottom portion of the chuck table 6 through the through-hole formed in a central portion of the table base 14. When the rotational drive source 16 is operated, the chuck table 6 is rotated around the rotary shaft 16a. At a lower portion of the table base 14 and in a periphery of the rotational drive source 16, an inclination adjusting mechanism (not illustrated) for supporting the table base 14 and adjusting inclination of the rotary shaft 16a relative to the Z-axis direction is provided.

The inclination adjusting mechanism has, for example, one fixed shaft and two movable shafts. By adjusting a height position for supporting the table base 14 by the movable shafts, the inclination of the rotary shaft 16a relative to the Z-axis direction is determined. The rotary shaft 16a is adjusted in its inclination angle such that part of the holding surface 6a becomes substantially parallel to an X-Y plane. The inclination adjusting mechanism is supported by a rectangular moving plate 18. The moving plate 18 is slidably attached onto a pair of guide rails 20 disposed substantially in parallel to the X-axis direction. Note that in FIG. 2, one guide rail 20 is depicted.

On a lower surface side of the moving plate 18, a nut section 22 is provided. A ball screw 24 disposed substantially in parallel to the X-axis direction is rotatably connected to the nut section 22. A rotational drive source 26 such as a pulse motor is connected to an end portion on the rear side of the ball screw 24 (one side in the X-axis direction). The moving plate 18, the guide rails 20, the nut section 22, the ball screw 24, and the rotational drive source 26 constitute an X-axis moving mechanism 8. The X-axis moving mechanism 8 causes the chuck table 6 to move between a loading/unloading region A1 located on a front side of the opening 4a (the other side in the X-axis direction) and a grinding region A2 located on a rear side of the opening 4a.

On the chuck table 6 disposed in the loading/unloading region A1, a front surface 11a side of a disc-shaped workpiece 11 is mounted. The workpiece 11 is, for example, a silicon-base disc-shaped wafer formed with a plurality of devices (not illustrated) on the front surface 11a side. It is to be noted, however, that the workpiece 11 may be formed from a compound such as silicon carbide (SiC) or gallium nitride (GaN), or may be formed from other materials. To the front surface 11a side of the workpiece 11, a resin-made protective tape 13 is attached.

When the workpiece 11 has its front surface 11a side held on the holding surface 6a through the protective tape 13, its back surface 11b side is exposed on the upper side. In a periphery of the chuck table 6, a chuck table cover 28 is provided in such a manner that the holding surface 6a is exposed. On both sides in the X-axis direction of the chuck table cover 28, bellows covers 30 are provided. The bellows covers 30 shrink and extend in the X-axis direction, according to movement of the chuck table 6 in the X-axis direction. On the rear side of the base 4, a quadrangular prismatic column 32 is provided.

On the front side of the column 32, a grinding feeding mechanism (processing feeding mechanism) 34 is provided. The grinding feeding mechanism 34 has a pair of rails 36 fixed to a front surface of the column 32. To each of the rails 36, a Z-axis moving plate 40 is slidably attached through a slider 38. On the rear side of the Z-axis moving plate 40, a nut section 42 is provided. A ball screw 44 provided along the Z-axis direction between the pair of rails 36 is rotatably connected to the nut section 42.

A rotational drive source 46 such as a pulse motor is connected to an upper end portion of the ball screw 44. When the ball screw 44 is rotated by the rotational drive source 46, the Z-axis moving plate 40 is moved in the Z-axis direction along the rails 36. On a front surface of the Z-axis moving plate 40, a grinding unit (processing unit) 48 is fixed in such a manner as to be movable in the Z-axis direction by the grinding feeding mechanism 34. The grinding unit 48 has a cylindrical holding member 50 fixed to the front surface of the Z-axis moving plate 40.

A cylindrical spindle housing 52 disposed substantially in parallel to the Z-axis direction is disposed inside the holding member 50. In the spindle housing 52, part of a cylindrical spindle 54 disposed substantially in parallel to the Z-axis direction is rotatably held. A rotational drive source 54a such as a servo motor is provided at an upper end portion of the spindle 54. A lower end portion of the spindle 54 is projecting to a position below a lower end of the spindle housing 52, and a disc-shaped mount section (wheel mount) 56 is fixed to the lower end portion of the spindle 54.

An annular grinding wheel (processing tool) 58 is mounted to a lower surface side of the mount section 56 by fixing members (not illustrated) such as screws. The grinding wheel 58 has an annular wheel base 58a formed from a metallic material such as an aluminum alloy, and a plurality of grindstones 58b fixed to a lower surface side of the wheel base 58a. The plurality of grindstones 58b are arranged in an annular pattern along the circumferential direction of the lower surface of the wheel base 58a in such a manner that a spacing is provided between the adjacent grindstones 58b. The grindstones 58b are formed, for example, through the steps of mixing a binder such as metal, ceramic, or resin with abrasive grains of diamond, cubic boron nitride (cBN), or the like, molding, firing, and the like.

A plurality of grinding water supply ports (not illustrated) are provided on the inner side than the grindstones 58b, in a discrete manner along the circumferential direction of the lower surface of the wheel base 58a. In addition, the wheel base 58a, the mount section 56, the spindle 54, and the like are provided with channels (not illustrated) for supplying grinding water such as pure water to each grinding water supply port. A grinding water supply unit (not illustrated) is connected to one end of the channels. At the time of grinding, the grinding water is supplied to the grindstones 58b, so that the grinding water containing the grinding swarf is scattered to the periphery. In order to reduce the scattering range of the grinding water containing the grinding swarf, a processing chamber cover 60 is provided in the grinding region A2.

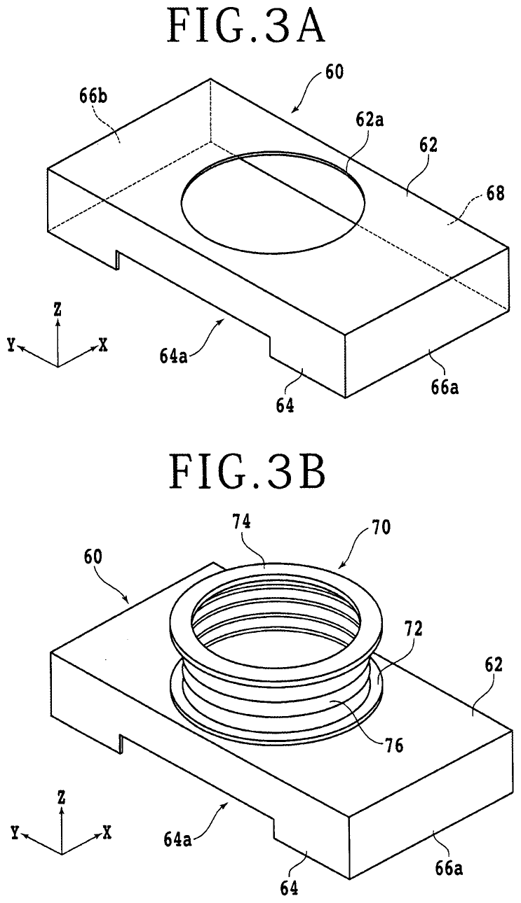

FIG. 3A is a perspective view of the processing chamber cover 60. Note that in FIG. 1, the processing chamber cover 60 is depicted in a broken line. The processing chamber cover 60 has a rectangular upper plate 62. The upper plate 62 is formed with an opening 62a having such a diameter that the mount section 56 and the grinding wheel 58 can penetrate the opening 62a. A front plate 64, side plates 66a and 66b, and a back plate 68 are connected to a peripheral portion of the upper plate 62 in such a manner as to project downward from the upper plate 62. The side plates 66a and 66b and the front plate 64 are connected to each other, and the side plates 66a and 66b and the back plate 68 are also connected to each other. The front plate 64 is formed with a rectangular cutout 64a so as to enable the chuck table 6 to move in and out. An upper end of the cutout 64a is located at a position higher than the back surface 11b of the workpiece 11 of which the front surface 11a side is held on the holding surface 6a.

A space defined by the processing chamber cover 60, the chuck table cover 28, and the like is a processing chamber 60a (see FIG. 2). The processing chamber cover 60 and the like can cover at least lateral sides of the mount section 56, the grinding wheel 58, and the chuck table 6 disposed in the grinding region A2. At the time of replacing the grinding wheel 58 and at the time of maintenance of the grinding apparatus 2, the processing chamber 60a can be opened. For example, the processing chamber cover 60 is configured to be able to be disassembled, and, at the time of maintenance, the processing chamber 60a is opened by disassembling of the processing chamber cover 60.

As depicted in FIG. 3B, the upper plate 62 of the processing chamber cover 60 is provided with an extendable cover section 70. FIG. 3B is a perspective view of the processing chamber cover 60 and the extendable cover section 70. Note that, in FIGS. 1 and 3A above, for the sake of convenience, the extendable cover section 70 is omitted. The extendable cover section 70 has an annular lower ring (lower connection section) 72 and an upper ring (upper connection section) 74 which are each formed from metal. The lower ring 72 is detachably connected to a peripheral portion of the opening 62a of the upper plate 62.

For example, permanent magnets (not illustrated) are provided at a peripheral portion of the opening 62a of the upper plate 62 making contact with the lower ring 72. When the lower ring 72 is brought into contact with the upper plate 62, the lower ring 72 is connected to the upper plate 62 by a magnetic force. It is to be noted, however, that the connection between the lower ring 72 and the upper plate 62 is not limited to the one implemented by the magnetic force. The lower ring 72 and the upper plate 62 may be detachably connected by a manual opening/closing type or automatic opening/closing type clamp mechanism (not illustrated).

On the other hand, the upper ring 74 is fixed to a flange 52a provided on the spindle housing 52, through fixing members (not illustrated) such as screws. In addition, the upper ring 74 is provided with permanent magnets (not illustrated) for tentatively fixing the lower ring 72 to the upper plate 62. When the lower ring 72 is detached from the upper plate 62 and raised and brought into contact with the upper ring 74, the lower ring 72 is held on the magnetic force in a state of being in contact with the upper ring 74.

The lower ring 72 and the upper ring 74 are connected by a tubular bellows section 76 which can shrink and extend in the Z-axis direction. The spindle housing 52 and the spindle 54 are disposed inside the bellows section 76. For example, in a case where the grinding unit 48 is moved upward and downward along the Z-axis direction, the bellows section 76 deforms according to the upward and downward movement of the grinding unit 48.

At the time of grinding the workpiece 11, first, the chuck table 6 with the front surface 11a side held under suction on the holding surface 6a thereof is moved into the grinding region A2 (see FIG. 2). Then, the chuck table 6 is rotated around the rotary shaft 16a. Moreover, the spindle 54 is rotated while the grinding water is being supplied from each of the grinding water supply ports, and in addition, the grinding unit 48 is put into downward processing feeding by the grinding feeding mechanism 34. When the grindstones 58b make contact with the back surface 11b of the workpiece 11, the back surface 11b side is ground.

At the time of grinding, the grinding water containing the grinding swarf is scattered in a mist form to the periphery, but the scattering range of the mist of the grinding water is reduced to a certain extent by the processing chamber cover 60. Note that the mist of the grinding water filling up the processing chamber 60a is sucked by a suction device (not illustrated) connected to the inside of the processing chamber 60a through a predetermined duct (not illustrated). However, even when the processing chamber 60a is sucked by the suction device, the mist of the grinding water cannot be completely sucked. Therefore, part of the mist of the grinding water leaks out to the upper side through the opening 62a of the upper plate 62, so that a large number of grinding swarf particles are deposited on the inside of the bellows section 76.

Therefore, when the bellows section 76 is shrunk such that the lower ring 72 makes contact with the upper ring 74 at the time of maintenance of the grinding apparatus 2, the grinding swarf falls, to be attached to the holding surface 6a and devices disposed in the processing chamber 60a. As an example of the devices, there is a contact-type thickness measuring instrument 78 (see FIG. 1) that is disposed in the processing chamber 60a in the vicinity of the opening 4a, for measuring the thickness of the workpiece 11 during grinding (see FIG. 1). In addition, as another example of the devices, there is a grinding water supply nozzle (not illustrated) for supplying grinding water to a ground region of the workpiece 11, separately and independently from the grinding wheel 58.

As depicted in FIG. 2, in the present embodiment, for preventing the grinding swarf from falling onto the devices and the holding surface 6a, a gas flow forming unit 80 for forming a flow of gas from the upper ring 74 toward the lower ring 72 in the inside of the bellows section 76 during grinding the workpiece 11 is provided. The gas flow forming unit 80 in the present embodiment has an air supply unit 82. The air supply unit 82 includes a compressor (not illustrated) for compressing air (gas), an air tank (not illustrated) for reserving compressed air, a filter for removing dust from the air when the compressed air is supplied from the air tank, and the like. It is to be noted that, however, the gas to be supplied from the gas flow forming unit 80 is not limited to the air. For example, by providing an inert gas supply source (not illustrated), in place of the air supply unit 82, the gas flow forming unit 80 may form a flow of an inert gas in the inside of the bellows section 76.

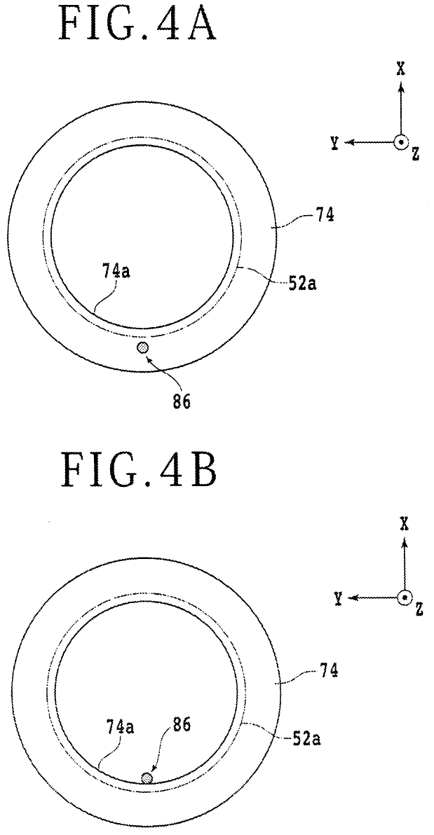

One end of one air supply channel 84 is connected to the air supply unit 82 of the present embodiment, and one nozzle 86 is connected to the other end of the air supply channel 84. In addition, the air supply channel 84 is provided with a solenoid valve (not illustrated) for controlling jetting of air and stoppage of jetting of air. The nozzle 86 is fixed to a through-opening (not illustrated) which is formed in part of the upper ring 74 and which communicates with the inside of the bellows section 76 (see FIG. 4A). FIG. 4A is a top plan view of the upper ring 74 depicting an example of a layout of the nozzle 86.

The nozzle 86 is located on a side outer than a peripheral end portion of the flange 52a fixed to the upper ring 74. From the nozzle 86, air is jetted in a predetermined flow rate to such an extent that no turbulence is generated inside the bellows section 76. For example, air is jetted in a flow rate of 100 (L/min). By the air jetted from the nozzle 86, a downward flow of air is formed inside the bellows section 76. This downward flow of air makes it difficult for the mist of the grinding water containing the grinding swarf to scatter from the processing chamber 60a to the bellows section 76, so that an amount of the grinding swarf that could be attached to the inside of the bellows section 76 can be reduced.

A timing and a period of time as well as a flow rate of jetting of air from the nozzle 86 are controlled by a control section (not illustrated) of the grinding apparatus 2. The control section controls opening and closing of a solenoid valve provided in the air supply channel 84, to thereby jet air from the nozzle 86, for example, from the time of starting rotation of the spindle 54 to the time of finishing the rotation. The control section controls operations of the chuck table 6, the X-axis moving mechanism 8, the grinding feeding mechanism 34, and the like, in addition to the air supply channel 84 and the nozzle 86. The control section includes a computer including a processing device such as central processing unit (CPU) and a storage device such as a flash memory. By operating the processing device according to software such as a program stored in the storage device, the control section functions as specific means in which the software and the processing device (hardware resource) cooperate with each other.

Note that the layout of the nozzle 86 is not limited to that depicted in FIG. 4A. The nozzle 86 may be disposed so as to make contact with an inner circumferential edge 74a of the upper ring 74 and to be located on the outside of the spindle housing 52, as depicted in FIG. 4B. FIG. 4B is a top plan view of the upper ring 74 depicting another example of the layout of the nozzle 86. Besides, the position of disposing the nozzle 86 is not limited to the front side of the inner circumferential edge 74a of the upper ring 74, and the nozzle 86 may be disposed at any position such as the rear side of the inner circumferential edge 74a. In any way, the downward flow of air enables the amount of grinding swarf that could be attached to the inside of the bellows section 76 to be reduced.

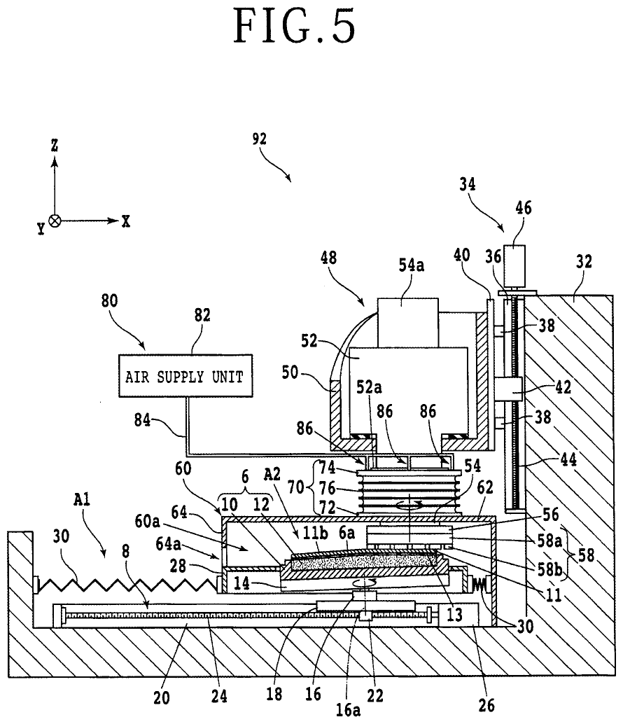

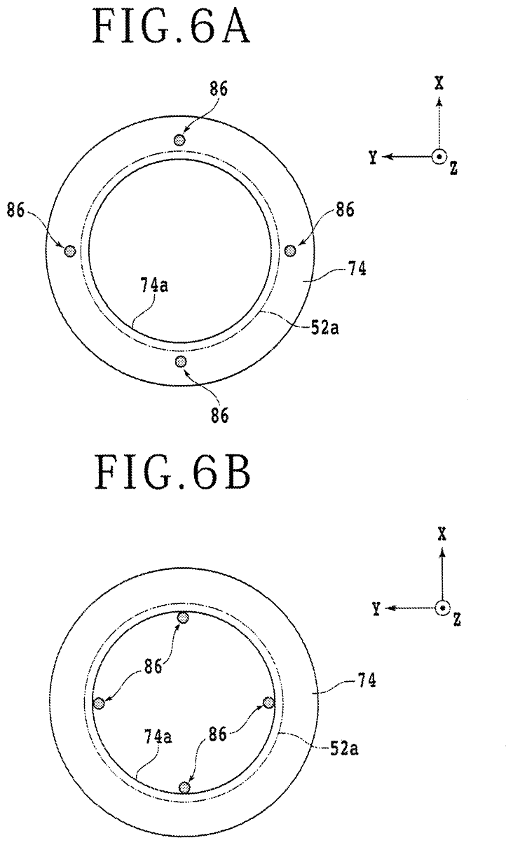

Next, a second embodiment will be described. FIG. 5 is a partly sectional side view of a grinding apparatus 92 according to the second embodiment. The grinding apparatus 92 has a plurality of nozzles 86 connected to the other end side of the air supply channel 84. In such a point, the second embodiment differs from the first embodiment. FIG. 6A is a top plan view of the upper ring 74 depicting an example of a layout of the plurality of nozzles 86. The upper ring 74 is formed with a plurality of through-openings (not illustrated) formed discretely along the circumferential direction of the upper ring 74, and one nozzle 86 is fixed to each of the through-openings.

Note that the layout of the plurality of nozzles 86 is not limited to that depicted in FIG. 6A. As depicted in FIG. 6B, the plurality of nozzles 86 may be disposed so as to make contact with the inner circumferential edge 74a of the upper ring 74 and to be located outside the spindle housing 52. FIG. 6B is a top plan view of the upper ring 74 depicting another example of the layout of the plurality of nozzles 86. The number of the plurality of nozzles 86 is not limited to four. Three or five or more nozzles 86 may be disposed discretely along the circumferential direction of the upper ring 74. The plurality of nozzles 86 may be disposed at substantially regular intervals along the circumferential direction of the upper ring 74.

With the plurality of nozzles 86 provided, the region where a downward flow of air is not formed inside the bellows section 76 can be reduced, as compared to the case where one nozzle 86 is provided. Therefore, as compared to the first embodiment, the amount of grinding swarf that could be attached to the inside of the bellows section 76 can be further reduced. In one example, twenty-four nozzles 86 are provided at substantially regular intervals along the circumferential direction of the upper ring 74, and air is jetted from each nozzle 86 at a flow rate of 100 (L/min). Note that, by inclining an orientation of each nozzle 86 by a predetermined angle from the Z-axis direction, a swirl flow may be formed inside the bellows section 76.

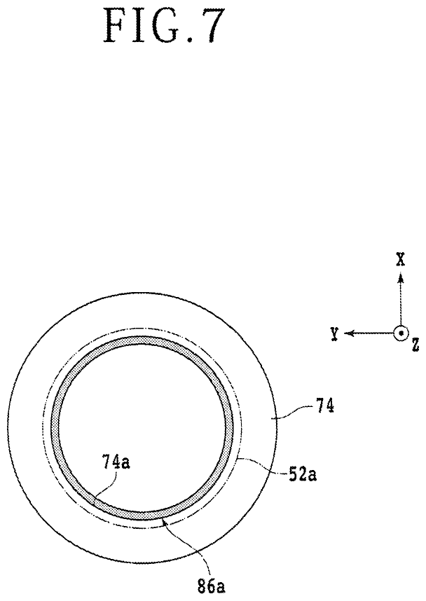

Next, a third embodiment will be described. FIG. 7 is a top plan view of the upper ring 74 depicting an example of a layout of one nozzle 86 according to the third embodiment. In the third embodiment, one annular nozzle 86a is connected to the other end side of the air supply channel 84. In such a point, the third embodiment differs from the first embodiment. The annular nozzle 86a is disposed so as to make contact with the inner circumferential edge 74a of the upper ring 74. The annular nozzle 86a has an annular opening (not illustrated) having a diameter of a predetermined width larger than the diameter of the spindle housing 52 but smaller than the diameter of the inner circumferential edge 74a.

The annular nozzle 86a forms a downward flow of air inside the bellows section 76. Particularly, the annular nozzle 86a can form a downward flow of air all over the circumferential direction of a side surface of the spindle housing 52, and therefore, the amount of grinding swarf that could be attached to the inside of the bellows section 76 can be further reduced, as compared to the first and second embodiments. Other than those described above, the structures, methods, and the like according to the embodiments can be modified, as required, in carrying out the present invention insofar as the modifications do not depart from the scope of the object of the present invention. For example, the gas flow forming unit 80 can include a suction unit (not illustrated) in addition to the air supply unit 82, the air supply channel 84, and the one or multiple nozzles 86 or the annular nozzle 86a. The suction unit has a negative pressure generation source such as an ejector. One end of a channel is connected to the negative pressure generation source, and the other end of the channel is disposed at the lower ring 72. By sucking air or the like from the inside of the bellows section 76 by the suction unit, a much stronger downward flow of air can be formed inside the bellows section 76.

Incidentally, while the grinding apparatuses 2 and 92 have been described in the abovementioned embodiments, the extendable cover section 70 and the gas flow forming unit 80 are applicable also to a polishing apparatus (processing apparatus). In the polishing apparatus, processing tools each having a disc-shaped base member and a polishing pad are mounted to a bottom surface side of a disc-shaped mount section 56. In wet polishing, the downward flow of air ensures that a mist-form polishing liquid or the like containing polishing swarf is less liable to be scattered from the processing chamber 60a to the bellows section 76. In addition, in dry polishing, the downward flow of air ensures that polishing powder is less liable to be scattered from the processing chamber 60a to the bellows section 76. Therefore, the amount of polishing swarf that could be attached to the inside of the bellows section 76 can be reduced. Note that, in the polishing apparatus, by providing a suction unit in addition to the gas flow forming unit 80, a much stronger downward flow of air can be formed inside the bellows section 76.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A processing apparatus comprising:
a chuck table having a holding surface for holding a workpiece;
a processing unit that has a spindle, a spindle housing holding the spindle in a rotatable manner, and a mount section fixed to a lower end portion of the spindle projecting below the spindle housing, the processing unit processing the workpiece held on the holding surface by a processing tool mounted to a lower surface side of the mount section;
a processing feeding mechanism that puts the processing unit into downward processing feeding;
a processing chamber cover that has an opening penetrable by the mount section and that is able to cover the chuck table and the mount section;
an extendable cover section having an annular lower connection section detachably connected to a peripheral portion of the opening, an annular upper connection section fixed to the spindle housing, and a tubular bellows section that connects the upper connection section and the lower connection section and that is able to shrink and extend following upward and downward movement of the processing unit; and
a gas flow forming unit that forms a flow of gas from the upper connection section toward the lower connection section inside the bellows section.

2. The processing apparatus according to claim 1,
wherein the gas flow forming unit has any one of
one nozzle disposed at the upper connection section,
a plurality of nozzles disposed discretely at the upper connection section along a circumferential direction of the upper connection section, and
an annular nozzle disposed at the upper connection section.
